(19) United States
(12) Patent Application Publication
(10) Pub. No.: US 2017/0001814 A1
(43) Pub. Date: Jan. 5, 2017

(54) JIG FOR LOADING PLATE GLASS OF TEMPERED GLASS MANUFACTURING APPARATUS

(71) Applicant: Ho Kwon KIM, Daegu (KR)

(72) Inventor: Ho Kwon KIM, Daegu (KR)

(21) Appl. No.: 15/105,241

(22) PCT Filed: Dec. 15, 2014
(86) PCT No.: PCT/KR2014/012366

§ 371 Date: Jun. 16, 2016

(30) Foreign Application Priority Data
Dec. 16, 2013 (KR) 10-2013-0156226

(51) Int. Cl. B65G 49/06; C03C 21/00

(52) U.S. Cl. CPC B65G 49/061; C03C 21/002

(57) ABSTRACT

A jig for loading plate glass of a tempered glass manufacturing apparatus. The present invention includes, inside of a jig (100) for holding plate glass (110), a width control means (120) and a height control means (130), which can vary horizontal and vertical widths according to a plate glass (110) standard, thereby enabling the plate glass to be stably loaded with one jig (100) irrespective of a change in the plate glass (110) standard when the plate glass (110) requiring tempering needs to be transferred in a tempered glass manufacturing apparatus capable of chemical strengthening.

### TECHNICAL FIELD

The present invention relates to a jig for loading plate glass of an tempered glass manufacturing apparatus, and more particularly, to a jig for loading plate glass of a tempered glass manufacturing apparatus having a height control means and a width control means capable of changing vertical and horizontal widths according to a standard of plate glass inside a jig that mounts the plate glass when attempting to transfer plate glass which requires to be tempered in the tempered glass manufacturing apparatus, thereby stably loading the plate glass with one jig regardless of a change in the standard of the plate glass.

### BACKGROUND ART

Generally, tempered glass is often used for a screen of a display apparatus, and a process for tempering glass is required to manufacture tempered glass with excellent hardness and strength.

Normally, tempering of glass is mainly classified as physical tempering and chemical tempering. Generally, physical tempering refers to a method of strengthening an inner strength of glass which uses glass having a thickness of 5 mm or more, heats the glass at a temperature between 550° C. and 700° C., and rapidly cools the glass. Physical cooling is mainly used for a tempered glass door, vehicular glass, etc.

Meanwhile, chemical tempering refers to tempering glass by dipping thin plate glass in a tempering furnace which contains a potassium nitrate solution for three hours or more and exchanging sodium ions in the glass with potassium ions in the potassium nitrate solution, and is mainly used in tempering thin plate glass having a thickness of 2.0 mm or less.

Recently, a manufacturing apparatus capable of manufacturing tempered glass through a method of performing ion exchanges by having a small amount of molten rock salt contained in melt which contains molten potassium salt to accelerate a reaction speed of ion exchanges between sodium ions and potassium ions on a glass surface layer has been suggested.

FIG. 1 is a perspective view of a tempered glass manufacturing apparatus which chemically manufactures tempered glass using a potassium nitrate solution.

The tempered glass manufacturing apparatus includes a main frame (1), guide rails installed in parallel at both vertical and horizontal sides of the main frame (1), a rack gear (12) which transmits power, a loading robot (2)and an unloading robot (3) which consecutively transfer a rack gear (12) on which multiple layers of glass are mounted along the guide rails (11) to allow the multiple layers of glass to be transferred to a preheating bath (4), a tempering bath (5), a slow cooling bath (6), a hot water bath (7), and a heat bath (8) to be tempered, wherein the rack gear (12) on which the multiple layers of tempered glass are mounted is carried to the outside. The tempered glass manufacturing apparatus further includes a control box (13) which generally manages the tempered glass manufacturing apparatus.

As above, the tempered glass manufacturing apparatus includes the main frame (1) as a basic frame, the guide rails (11) installed in parallel at both vertical and horizontal sides of the main frame (1) so that robots may move in parallel, the preheating bath (4) which firstly heats glass before the glass is tempered at an inner lower portion of the main frame (1) to prevent thermal deformation and cracking of the glass when the glass is being tempered, the tempering bath (5) which heats and melts KNO₃ therein and maintains KNO₃ in a molten state to adjust a tempering temperature, the slow cooling bath (6) which slowly cools a temperature of the glass tempered in the tempering bath (5) to remove stress, and the hot water bath (7) and the heat bath (8) which clean the tempered glass cooled in the slow cooling bath (6).

In the tempered glass manufacturing apparatus illustrated in FIG. 1, the six baths are installed apart from each other in a longitudinal direction, each of the baths includes an inner heating unit in which a heater is embedded and a door foldably opened and closed along a door rail installed at an upper portion to maintain a temperature or prevent impurities from being mixed into the bath.

In a treatment of tempering disk glass, disk glass preheated in the preheating bath (4) is dipped in the tempering bath (5) by a process in which the loading robot horizontally moves a rack on which the disk glass is mounted by power of a motor.

When the process of tempering disk glass is performed, a temperature of the glass is increased to 380° C. to 500° C. by preheating, the temperature is maintained for 30 minutes to 120 minutes, the glass is dipped for 4 to 6 hours in the potassium nitrate solution (KNO₃) which is heated to 450° C. in the tempering bath (5) to be tempered, the glass is moved to the slow cooling bath (6) to allow the tempered glass to be slowly cooled to reach 100° C. and stress to be removed therefrom, and the tempered glass is firstly and secondly cleaned in the hot water bath and the heat bath.

The disk glass to be tempered which is transferred in the process of tempering the disk glass is loaded on a jig and moved by the loading robot according to a process sequence.

Here, since a structure of the jig on which the disk glass is loaded has a fixed shape, there is a problem of requiring multiple jigs according to a standard or size of disk glass.

Meanwhile, a technology related to a jig used in a tempered glass manufacturing apparatus is disclosed in Korean Patent Registration Number 1061650 (announced on Sep. 1, 2011) and Korean Patent Publication Number 2011-0135573 (published on Dec. 19, 2011).

### DISCLOSURE

### Technical Problem

Thus, the present invention has been devised to improve the problem of a jig used in a tempered glass manufacturing apparatus described above and is directed to providing a jig for loading plate glass of a tempered glass manufacturing apparatus having a height control means and a width control means capable of changing vertical and horizontal widths according to a standard of plate glass inside a jig that mounts the plate glass when attempting to transfer plate glass which requires to be tempered in the tempered glass manufacturing apparatus, thereby stably loading the plate glass with one jig regardless of a change in the standard of the plate glass.

### Technical Solution

To achieve the above objective, there is provided a jig for loading plate glass which is used to load plate glass in a tempered glass manufacturing apparatus and which has a rectangular parallelepiped frame structure formed of lower and upper frames which are formed by a plurality of support beams and side frames formed by a plurality of support beams which connect the lower and upper frames. The jig for loading plate glass of the tempered glass manufacturing apparatus includes a plurality of guide rails disposed inside the lower frame and spaced apart at predetermined intervals, a plurality of width control means disposed to be movable along the guide rails by being perpendicularly fitted and coupled with respect to the guide rails, disposed to adjust widths of support points to allow plate glass to be supported by a plurality of support points corresponding to a length of a width of the plate glass, and each having a plurality of seating grooves capable of fitting and fixing a lower end surface of the plate glass, height control means formed of side slot bars disposed to be horizontal to the width control means, disposed at both upper side surfaces of the side frames to face each other, and including a plurality of slot grooves, height control guide beams vertically disposed along the side frames to be perpendicular to the side slot bars and having a plurality of height control holes formed at predetermined intervals, and fixing ports movably assembled to the height control guide beams to change or fix positions of the side slot bars, and support pin bars fitted to the slot grooves of the side slot bars disposed to face each other at the both side surfaces of the side frames to be adhered to and support an upper end of plate glass.

Here, each of the width control means may include a width control slot bar on which the plurality of seating grooves capable of fitting and fixing the lower end surface of the plate glass are formed at predetermined intervals, a round bar adhered to and fixed to side surfaces of the seating grooves of the width control slot bar to support the lower end of plate glass by coming into contact with the lower end of the plate glass, and a movement bar including a plurality of guide grooves formed to be movable along the guide rails while the width control slot bar and the round bar are coupled in parallel.

Here, a method of inserting a fixing pin fitted and fixed between the fixing ports and the height control holes may be preferably used as a method for aligning the fixing ports to the height control holes and fixing the fixing ports.

### Advantageous Effects

According to the present invention, by having a height control means and a width control means capable of changing vertical and horizontal widths according to a standard of plate glass inside a jig that mounts the plate glass, when attempting to transfer plate glass which requires to be tempered in the tempered glass manufacturing apparatus, the plate glass can be stably loaded with one jig regardless of a change in the standard of the plate glass.

### DESCRIPTION OF DRAWINGS

FIG. 1 is a perspective view illustrating an embodiment of a chemically tempered glass manufacturing apparatus according to the related art.

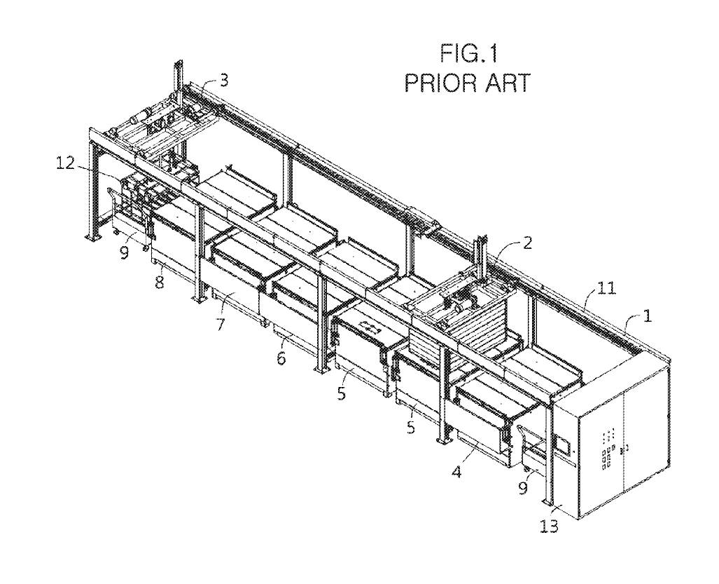

FIG. 2 is a view illustrating a preferred embodiment of a chemically tempered glass manufacturing apparatus according to the present invention.

FIG. 3 is a perspective view illustrating a configuration of a jig capable of loading plate glass according to the present invention.

FIG. 4 is a schematic side view of a state in which plate glass is loaded inside the jig illustrated in FIG. 3 viewed from one side surface according to the present invention.

FIG. 5 is a schematic side view of a state in which plate glass is loaded inside the jig illustrated in FIG. 3 viewed from the other side surface according to the present invention.

FIG. 6 is a plan view of the jig illustrated in FIG. 3 viewed from the top according to the present invention.

FIG. 7 is an enlarged view of portion A for showing a height control means illustrated in FIG. 4 according to the present invention.

FIG. 8 is an enlarged view of portion B for showing a width control means illustrated in FIG. 4 according to the present invention.

FIG. 9 is an enlarged view of portion C for showing a height control means illustrated in FIG. 5 according to the present invention.

FIG. 10 is an enlarged view of portion D for showing a width control means illustrated in FIG. 5 according to the present invention.

FIG. 11 is view illustrating a usage example which shows a state in which positions of the width control means and the height control means are adjusted as a standard of the plate glass illustrated in FIG. 4 is changed according to the present invention.

### MODES OF THE INVENTION

Hereinafter, a preferred embodiment of the present invention will be described in more detail with reference to the accompanying drawings.

Here, in describing the preferred embodiment of the present invention, thickness of lines or sizes of elements, etc. illustrated in the accompanying drawings may be exaggerated or omitted for clarity and convenience of description. Also, terms assigned according to reference numerals marked in the drawings are those defined in consideration of functions in the present invention and may be changed according to intentions or practices of a user or an operator.

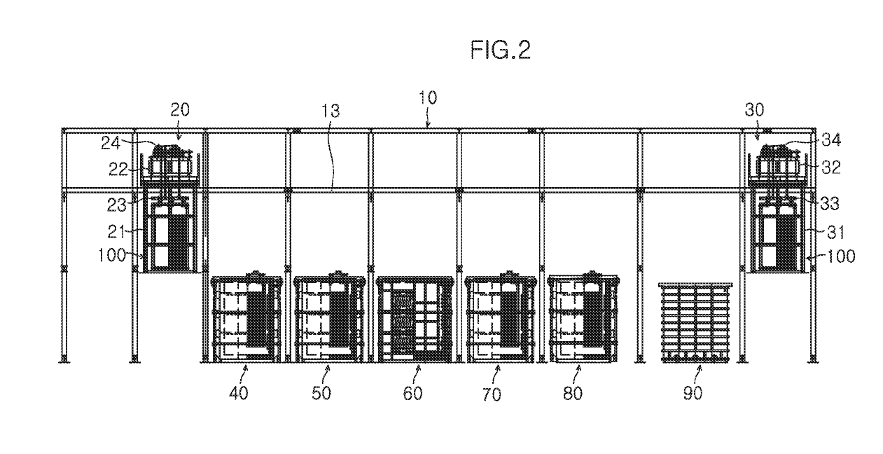

As illustrated in FIG. 2, a tempered glass manufacturing apparatus to which a jig for loading plate glass according to the present invention is applied mainly includes a structure 10 in which a series of devices required to perform each step such as transfer units 20 and 30, first and second preheating units 40 and 50, a chemical tempering unit 60, first and second slow cooling units 70 and 80, and a cleaning unit 90 unit are consecutively disposed in one line.

On a first floor of the structure 10, the first and second preheating units 40 and 50, the chemical tempering unit 60, the first and second slow cooling units 70 and 80, and the cleaning unit 90 unit are formed in the shape of a box having an opening on an upper portion thereof and are disposed in parallel in one line. On a second floor which is above the first floor of the structure 10, a first guide rail 13 is horizontally installed and the transfer units 20 and 30 which include casings 21 and 31 formed in the shape of a box having an opening at a lower portion thereof are disposed at left and right sides to face each other and be movable along the first guide rail 13.

In addition, an opening and closing door (not illustrated) which moves along a second guide rail is installed between the first floor d the second floor of the structure 10 to selectively open and close each opening of the first and second preheating units 40 and 50, the chemical tempering unit 60, and the first and second slow cooling units 70 and 80.

Here, as illustrated in FIG. the transfer units 20 and 30 are parts which consecutively convey plate glass 110 to be tempered to the first and second preheating units 40 and 50, the chemical tempering unit 60, the first and second slow cooling units 70 and 80, and the cleaning unit 90, and are configured to lift and lower the plate glass 110 to each processing part according to a consecutive process while a jig 100 for loading the plate glass 110 is disposed inside the transfer casings 21 and 31 formed of metal in a substantially rectangular shape.

The transfer units 20 and 30 include the transfer casings 21 and 31, guide transfer blocks 22 and 32, the e jig 100, jig holding beams 23 and 33, and lifting-and-lowering towing units 24 and 34.

As illustrated in FIG. 2, the lifting-and-lowering towing units 24 and 34 are parts which are fixed and installed on upper end surfaces of the guide transfer blocks 22 and 32 to hold the jig 100 on the jig holding beams 23 and 33 by driving force of a motor to convey the jig 100 in a vertical direction of the transfer casings 21 and 31.

Consequently, according, to the tempered glass manufacturing apparatus of the present invention illustrated in FIG. 2, multiple layers of plate glass 110 to be tempered are mounted on the jig 100, and the transfer units 20 and 30 move along the first guide rail 13 to move the jig 100 to each processing part for a process for manufacturing tempered glass.

In the tempered glass manufacturing apparatus having the configuration above, the jig 100 for loading which mounts and supports the plate glass 110 is configured to be universally used regardless of a standard of the plate glass.

That is, the jig 100 of the present invention is configured to stably mount plate glass by adjusting a mounting width and a mounting height corresponding to various standards of plate glass only with one jig 100 regardless of a change in the standard of the plate glass. Thus, even when the standards of plate glass vary when manufacturing tempered glass, chemical tempering may be performed with only one jig without replacing the jig.

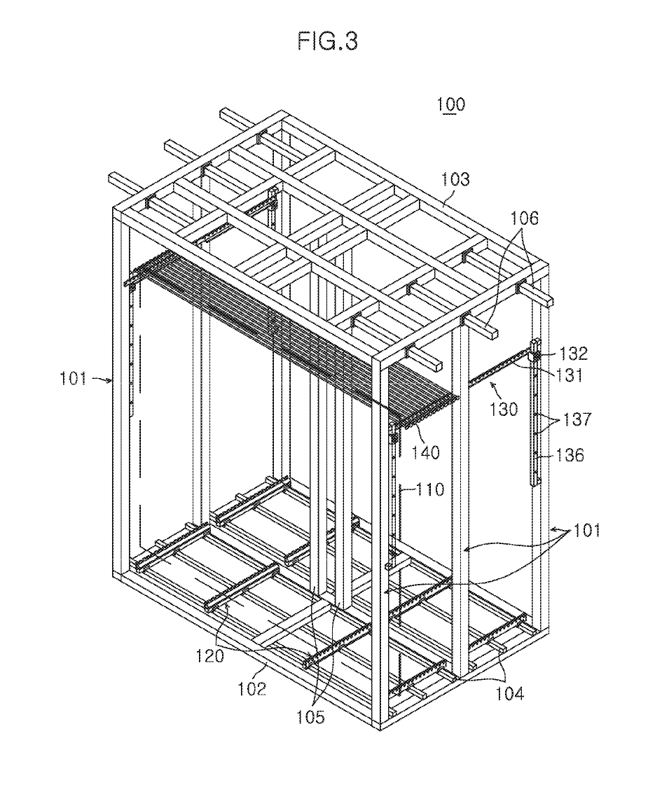

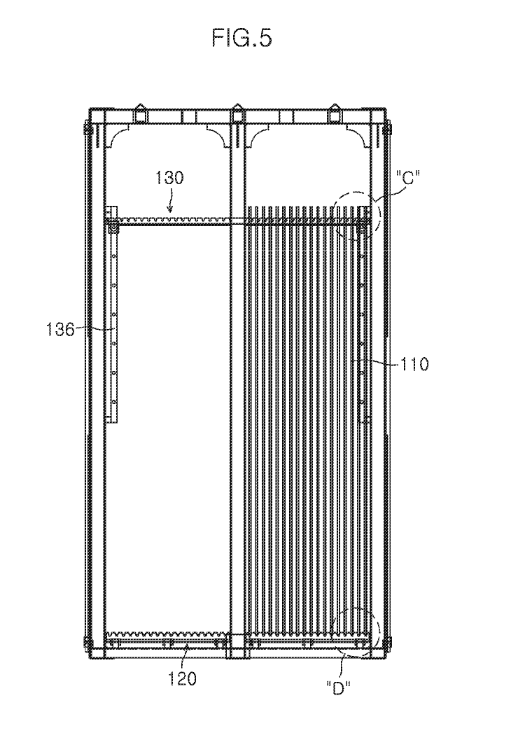

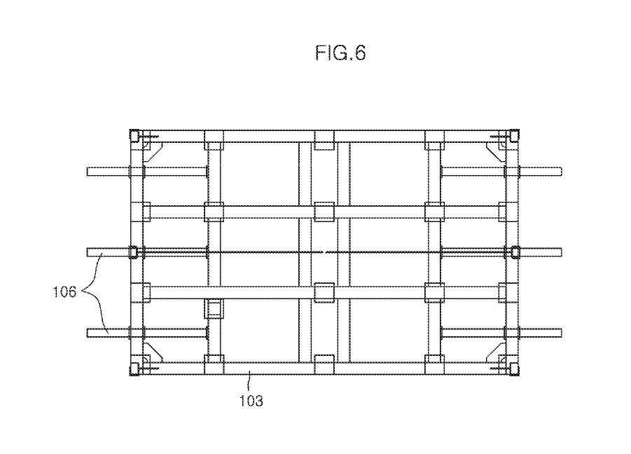

For this, the jig 100 according to the present invention has a frame structure illustrated in FIGS. 3 to 6.

That is, as illustrated in FIGS. 3 to 6, the jig 100 is a part which firmly mounts and supports various standards of plate glass 110 to be tempered according to each process of the tempered glass manufacturing apparatus to prevent the plate glass 110 from shaking, and has a rectangular parallelepiped frame structure which has six side surfaces including a pair of lower and upper frames 102 and 103 formed in a rectangular shape which is formed by a plurality of support beams disposed to face each other and side frames 101 formed of a plurality of support beams which connect the lower and upper frames 102 and 103.

Here, the lower and upper frames 102 and 103 are preferably formed by framing at least one support beam having a rectangular cross-section in horizontal and vertical directions inside a rectangular space for the strength of the frame structure.

In addition, as illustrated in FIG. 3, a reinforcing frame 105 for reinforcing the frame structure of the jig 100 is preferably formed at a central portion between the lower and upper frames 102 and 103.

In addition, among side surfaces of the upper frame 103 having a rectangular structure, a hanging shaft 106 on which a hook for lifting the jig 100 by the lifting-and-lowering towing units 24 and 34 is formed to protrude from both side surfaces of the upper frame 103 which have shorter lengths.

According to the present invention, the jig 100 for loading plate glass having the rectangular parallelepiped frame structure is configured such that a height and a width of a portion on which the plate glass 110 is mounted may be adjusted according to the standard of the plate glass 110 when the plate glass 110 is being mounted inside the jig 100.

For this, the jig 100 has a width control means 120 and a height control means 130 capable of mounting the plate glass in various ways according to the standard of the plate glass inside the jig 100.

The width control means 120 is a part which supports a lower end surface of the plate glass 110 mounted inside the jig 100 and includes a plurality of width control slat bars 122 capable of being moved so that positions of support points may be changed along a width length of the plate glass 110, a round bar 123 adhered to and fixed to side surfaces of the width control slot bars 122 to support a lower end of the plate glass 110 by corning into contact with the lower end surface of the plate glass 110, and a movement bar 121 including a plurality of guide grooves 125 formed to be movable along guide rails 104 while supporting the width control slat bars 122 and the round bar 123.

As illustrated in FIG. 3, since the guide rails 104 are disposed to extend in a length direction of the lower frame 102 (a longitudinal direction of the rectangular frame), three guide rails 104 form one group, and two groups of three guide rails 104 are disposed to be horizontally symmetrical to each other with respect to a central line of the lower frame 102 in the preferred embodiment of the present invention.

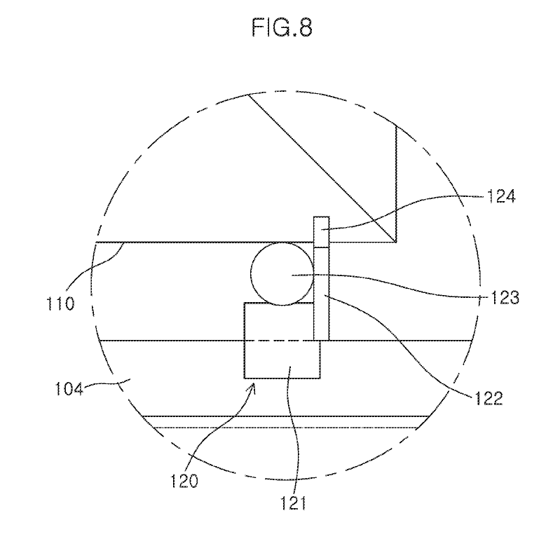

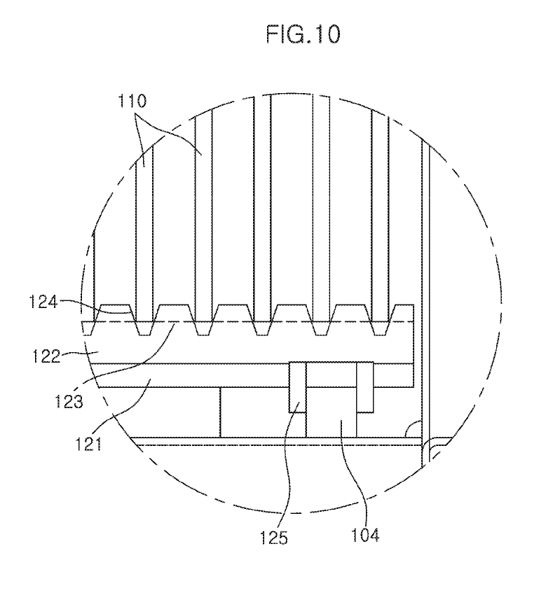

As illustrated in FIGS. 3 to 5, 8, and 10, the movement bar 121 has a rectangular cross-sectional structure, and has a structure formed such that the plurality of guide grooves 125 disposed in a structure which is perpendicular to a plurality of guide rails 104 disposed in the long direction (referring to the longitudinal direction in the rectangular space) inside the lower frame 102 are fitted and coupled to the plurality of guide rails 104 to be movable along the guide rails 104.

The width control slot bars 122 have a structure in which a plurality of seating grooves 124 formed substantially in a V-shape having a predetermined angle are repeatedly formed along the longitudinal direction so that the plate glass 110 may be easily fitted while being integrally coupled to the movement bar 121.

During the process of tempering the plate glass 110, the seating grooves 124 mount the plate glass 110 to prevent the plate glass 110 from being deviated while firmly supporting the plate glass 110 and prevent damage to a surface of the plate glass 110 by linear contact.

That is, the seating grooves 124 minimize an area coming into contact with the plate glass 110 to minimize cracks and faults that may occur while the plate glass 110 is being transported and tempered.

In addition, the round bar 123 having a circular cross-section which comes into contact with and supports the lower end of the plate glass 110 fitted and mounted on the seating grooves 124 is adhered and fixed to side surfaces of the seating grooves 124 of the width control slot bars 122.

Consequently, when the plate glass 110 is fitted and mounted on the seating grooves 124, the lower end of the plate glass 110 is placed on the round bar 123 such that a lower end portion of the plate glass 110 can be mounted while not being caught in the seating grooves 124 formed substantially in a V-shape, and the plate glass 110 may be stably supported and mounted with a sufficient strength by the round bar 123 even when a self-load of the plate glass 110 is extremely heavy due to its large size.

Here, the width control slot bars 122 and the round bar 123 are supported by being integrally coupled and fixed to an upper end portion of the movement bar 121 having a rectangular cross-section.

In addition, as described above, the guide grooves 125 fitted and asset bled to the guide rails 104 to be movable along the guide rails 104 are formed on a bottom surface of the movement bar 121, and the plurality of guide grooves 125 are formed in a structure which corresponds one to one with the guide rails 104 disposed at predetermined intervals.

In the preferred embodiment of the present invention, the six guide rails 104 and eight width control means 120 are separately disposed within the lower frame 102, and particularly, a group of four width control means 120 are disposed at the three guide rails 104, and two groups of four width control means 120 are disposed to be horizontally symmetrical to each other within the lower frame 102. However, embodiments are not limited thereto. That is, the numbers of the guide rails 104 and the width control means 120 may be selectively adjusted in various ways as needed.

In other words, the number of installed width control means 120 may be configured in various ways according to a design specification such as the number of points for mounting the lower end of the plate glass 110.

In addition, the height control means 130 according to the present invention are installed to be movable when a mounting height needs to b changed according to a height (a vertical length) of the plate glass 110.

The height control means 130 are disposed at both upper side surfaces of the side frames 101 to face each other and be horizontal to the width control means 120.

Here, the height control means 130 include side slot bars 131 in which a plurality of slot grooves 135 are formed, height control guide beams 136 vertically disposed along the side frames 101 to be perpendicular to the side slot bars 131 and having a plurality of height control holes 137 formed at predetermined intervals, and fixing ports 132 movably assembled to the height control guide beams 136 to change or fix positions of the side slot bars 131.

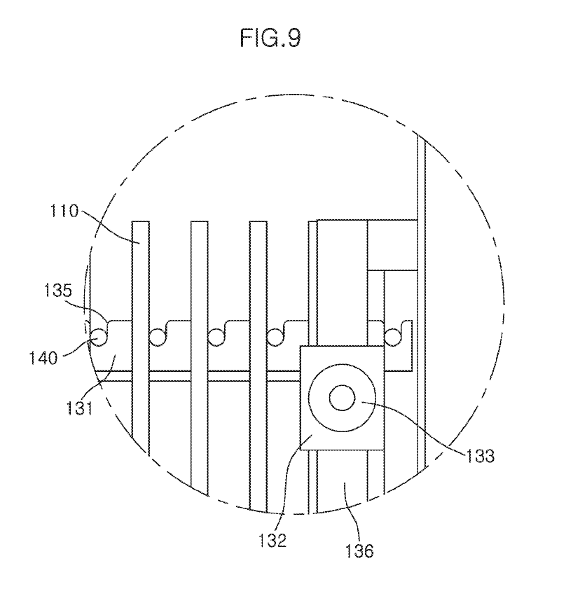

As illustrated in FIG. 9, the plurality of slot grooves 135 formed at the side slot bars 131 are grooves to which support pin bars 140, which are adhered to and support an upper end of the plate glass 110, are fitted and fixed, and have a substantially rounded groove structure.

The support pin bars 140 are fitted to the slot grooves 135 of the side slot bars 131 disposed to face each other at the both side surfaces of the side frames 101 to perform a role of being adhered to and supporting the upper end of plate glass 110.

The height control guide beams 136 are members which guide height adjustment, are vertically disposed in a structure of facing each other on sides of four corners that form the side frames 101, and include a plurality of height control holes 137 formed at predetermined intervals to adjust a height at which the side slot bars 131 are installed corresponding to a height (a horizontal length) of the plate glass 110.

The fixing ports 132 which support and fix both ends of the side slot bars 131 are disposed at the height control guide beams 136, and fixing pins 133 fitted and fixed to correspond to the height control holes 137 are detachably disposed at the fixing ports 132.

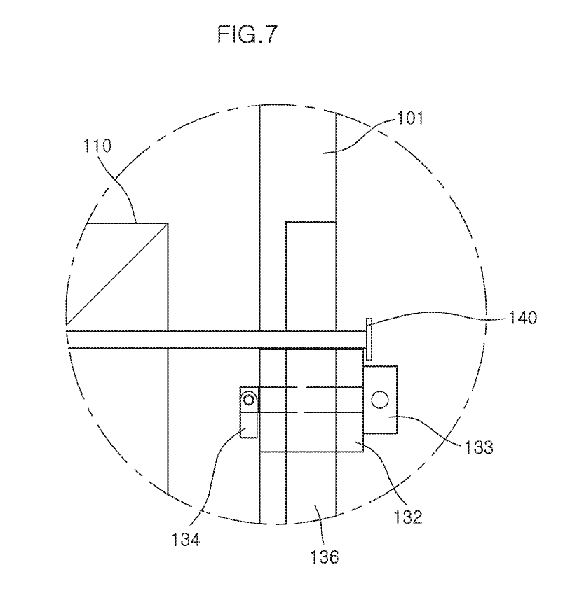

The fixing pins 133 perform a role of fitting and fixing positions of the fixing ports 132 to selected height control holes 137. Particularly, as illustrated in FIG. 7, a pin bending unit 134 is formed at one end of a fixing pin 133 to be rotated and bent to serve as a stopper.

That is, when the pin bending unit 134 is rotated and bent after the fixing pin 133 is fitted into a height control hole 137 corresponding to a fixing port 132, the fixing pin 133 does not deviate from the height control hole 137 unless the pin bending unit 134 is straightly unfolded.

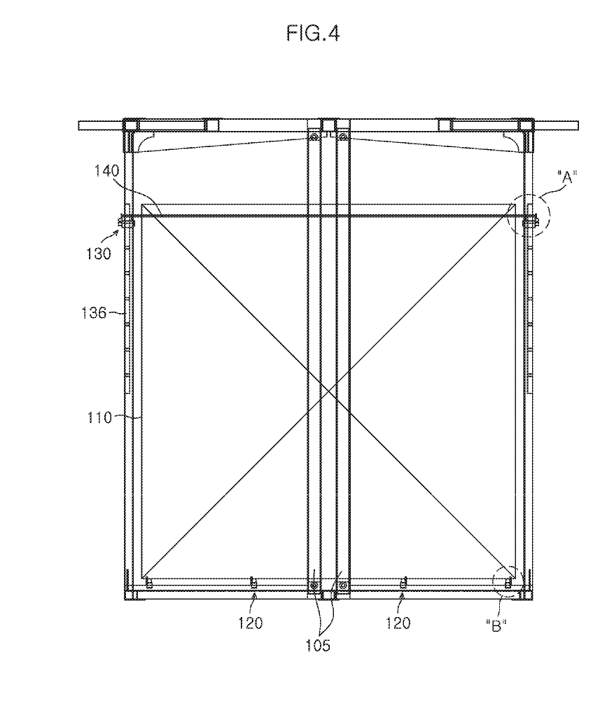

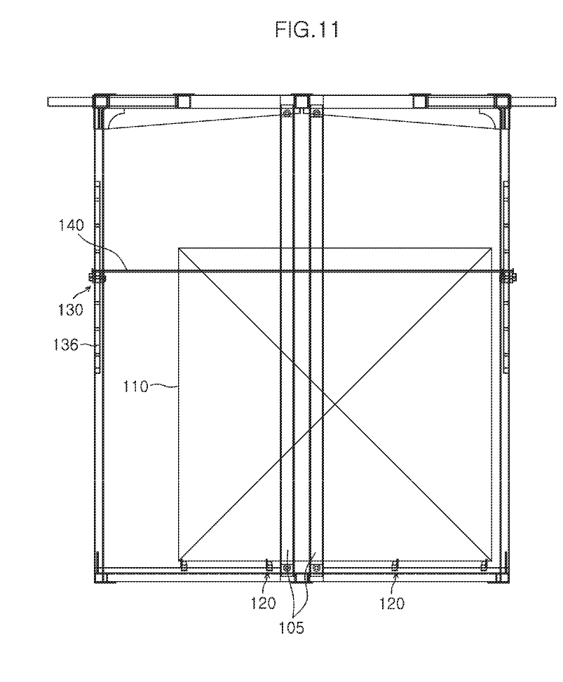

As described above, according to the present invention, by having the width control means 120 and the height control means 130 disposed on the jig 100, when the standard of the plate glass 110 changes as illustrated in FIGS. 4 and 11, positions of the width control means 120 and the height control means 130 are changed corresponding to the standard of the plate glass, and thus various standards of plate glass can be stably mounted even though the jig 100 is not replaced.

In addition, the plurality of support beams which form the lower and upper frames 102 and 103 and the side frames 101 that form the jig 100 are preferably formed with materials capable of minimizing thermal deformation in the process of manufacturing tempered glass.

Although the present invention has been described in detail only with respect to the detailed embodiment above, it should be apparent to those of ordinary skill in the art that various modifications and changes are possible within the technical scope of the present invention, and the modifications and changes of course belong to the attached claims.

### INDUSTRIAL APPLICABILITY

[symbol]

1. A jig for loading plate glass which is used to load plate glass in a tempered glass manufacturing apparatus and which has a rectangular parallelepiped frame structure formed of lower and upper frames which are formed by a plurality of support beams and side frames (101) formed by a plurality of support beams which connect the lower and upper frames, the jig comprising:
a plurality of guide rails disposed inside the lower frame and spaced apart at predetermined intervals;
a plurality of width control means disposed to be lovable along the guide rails by being perpendicularly fitted and coupled with respect to the guide rails, disposed to adjust widths of support points to allow plate glass to be supported by a plurality of support points corresponding to a length of a width of the plate glass, and each having a plurality of seating grooves capable of fitting and fixing a lower end surface of the plate glass (110);
height control means formed of side slot bars disposed to be horizontal to the width control means, disposed at both upper side surfaces of the side frames to face each other, and including a plurality of slot grooves, height control guide beams vertically disposed along the side frames to be perpendicular to the side slot bars and having a plurality of height control holes formed at predetermined intervals, and fixing ports movably assembled to the height control guide beams to change or fix positions of the side slot bars; and
support pin bars fitted to the slot grooves of the side slot bars disposed to face each other at the both side surfaces of the side frames to be adhered to and support an upper end of the plate glass.

2. The jig of claim 1, wherein each of the width control means includes a width control slot bar on which the plurality of seating grooves capable of fitting and fixing the lower end of the plate glass are formed at predetermined intervals, a round bar adhered to and fixed to side surfaces of the seating grooves of the width control slot bar to support the lower end of plate glass by coming into contact with the lower end of the plate glass, and a movement bar including a plurality of guide grooves formed to be movable along the guide rails while the width control slot bar and the round bar are coupled in parallel.

3. The jig of claim 1, wherein a method of inserting a fixing pin fitted and fixed between the fixing ports and the height control holes is used as a method for aligning the fixing ports to the height control holes and fixing the fixing ports.
